(19) United States
(12) Patent Application Publication
(10) Pub. No.: US 2003/0021426 A1
(43) Pub. Date: Jan. 30, 2003

(54) Base station, drive through system comprising the same, base station method, and drive through method

(76) Inventor: Shinichi Oogo, Kanagawa-ken (JP)

Correspondence Address: PEARNE & GORDON LLP, 526 SUPERIOR AVENUE EAST, SUITE 1200, CLEVELAND, OH, 44114-1484, US

(21) Appl. No.: 10/200,434

(22) Filed: Jul. 22, 2002

(30) Foreign Application Priority Data
Jul. 24, 2001 (JP) 2001-222474

(51) Int. Cl. H04B 15/00

(52) U.S. Cl. 381/93; 381/87; 186/41

(57) ABSTRACT

Herein disclosed is a base station and a base station comprising the base station, which does not limit the time period required for the processing performed by the signal processing section of the base station, but can prevent the talk back sound from being delayed and misheard for reverberations, thereby making it easy for an order taker to accurately take the order. The base station comprises: a base receiving section for receiving a far-end voice signal converted from a far-end voice; a signal processing section for generating a reverberation-free processed sound signal, the signal processing section including: a storing portion for storing the far-end voice signal received by the base receiving section; and an input signal processing portion for processing a near-end sound signal including a sound signal segments corresponding to the far-end voice to generate a processed near-end sound signal including a processed sound signal segments corresponding to the far-end voice, and adding the far-end voice signal stored by the storing portion to the processed near-end sound signal to generate the reverberation-free processed sound signal in which the processed sound signal segments corresponding to the far-end voice and the sound signal segments corresponding to the far-end voice are substantially matched, and a base transmitting section for transmitting the reverberation-free processed sound signal generated by the input signal processing portion.

### BACKGROUND OF THE INVENTION

1. Field of the Invention

The present invention relates to a base station for processing a voice spoken up by a clerk working in a shop and a voice spoken up by a client staying outside the shop and a drive through system comprising the same, and a base station method of processing a voice spoken up by a clerk working in a shop and a voice spoken up by a client staying outside the shop, and a drive through method comprising the same.

2. Description of the Related Art

Up until now, there have been proposed a wide variety of drive through systems, each of which makes it possible for a customer driving a car to give an order to a clerk working in the shop.

The conventional drive through systems of this type have so far been available especially in, for example, fast food restaurants and gift shops. One typical example of the conventional drive through system 300 is exemplified and shown in FIGS. 4 and 5. As best shown in FIG. 4, the conventional drive through system 300 thus exemplified comprises a menu board 310, an order taker headset 320, an order taker station 330, and a base station 340. The menu board 310 is placed outside of a shop and into which a customer driving a car, outside the shop, speaks up an order, for example, “One hamburger, please!” The order taker headset 320 is worn on the head of an order taker taking the order in the shop from the customer driving a car outside the shop. The order taker station 330 is carried by the order taker. The base station 340 is operative to receive signals from the menu board 310 and the order taker headset 320 through the order taker station 330. The term “order taker” herein used is intended to mean a clerk taking an order in a shop from a customer staying outside the shop. The order taker headset 320 is connected with the order taker station 330 through a cable 350.

The conventional drive through system will be described in detail with reference to the drawings shown in FIG. 5.

The menu board 310 includes a menu board microphone 312 and a menu board speaker 311. The menu board microphone 312 is operative to collect sounds around the menu board microphone 312, and convert the sounds thus collected into a menu board sound signal. The menu board speaker 311 is operative to input an order taker's voice signal received by the base receiving section 342, to convert the order taker's voice signal thus inputted into an order taker's voice, for example, “Hello! May I take your order?” and to audibly output the order taker's voice. The menu board 310 is placed outside the shop. A customer, for example but not limited to, driving a car may speak up an order into the menu board 310 in response to the order taker's voice. This means that the menu board microphone 312 is operative to collect the sound including the order “One hamburger, please!” spoken up by the customer and convert the sound including the order spoken up by the customer thus collected into a menu board sound signal.

The order taker headset 320 includes: an order taker head microphone 322 and an order taker head speaker 321. The order taker head microphone 322 is operative to input an order taker's voice, for example, “Hello! May I take your order?”, to convert the order taker's voice into an order taker's voice signal. The order taker head speaker 321 is operative to output the sound including the order, “One hamburger, please!” spoken up by the customer collected by the menu board microphone 312. Thus, the order taker wearing the order taker headset 320 can take an order.

The order taker station 330 includes: an order taker receiving section 331 and an order taker transmitting section 332. The order taker receiving section 331 is operative to receive a base station signal, which will be described later, transmitted by the base transmitting section 343 of the base station 340. The order taker transmitting section 332 is operative to transmit the order taker's voice signal converted by the order taker head microphone 322 to the base station 340.

The base station 340 comprises a base receiving section 342 for receiving an order taker's voice signal transmitted by the order taker transmitting section 332, a signal processing section 341 for processing the menu board sound signal converted by the menu board microphone 312, adding the menu board sound signal thus processed to the order taker's voice signal received by the base receiving section 342 to generate a base station signal, and a base transmitting section 343 for transmitting the base station signal thus generated.

In the conventional drive through system 300, the order taker's voice (hereinlater simply referred to as “original sound”) is inputted and converted into the order taker's voice signal by the order taker's head microphone 322, and the order taker's voice signal thus converted is transmitted by the order taker station 330 to the base receiving station 342. The order taker's voice signal received by the base receiving station 342 is inputted, converted into the order taker's voice and, the order taker's voice thus converted is audibly outputted by the menu board speaker 311. The order taker's voice audibly outputted by the menu board speaker 311 is reflected from objects surrounding the menu board 310 such as, for example, cars. The sounds including the order taker's voice reflected from the objects surrounding the menu board 310 (hereinlater simply referred to as “talk back sound”) are collected by the menu board microphone 312, in addition to the order spoken up by the customer. The menu board microphone 312 is operative to convert the sounds thus collected into the menu board sound signal. The menu board sound signal converted by the menu board microphone 312 is processed by the signal processing section 341. The processing performed by the signal processing section 341 may be, for example but not limited to, processing to reduce the noise components contained in the menu board sound signal converted by the menu board microphone 312. The order taker's voice signal received by the base receiving station 342 is also added to the menu board sound signal processed by the signal processing section 341, resulting in a base station signal. The base station signal is then transmitted by the base transmitting section 343 to the order taker receiving section 331 of the order taker station 330. The base station signal is then converted into a sound including the original sound, the talk-back sound, and the order spoken up by the customer, and talk-back sound, and the sound thus converted is audibly outputted by the order taker head speaker 321 of the order taker headset 320.

The base station signal contains sound signal segments corresponding to the original sound, the talk-back sound, and the order spoken up by the customer. As described above, the talk-back sound is a reflection of the original sound and should be audibly outputted by the order taker head speaker 321 substantially at the same time as the original sound. The menu board sound signal containing the talk back sound and the order spoken up by the customer, however, is processed by the signal processing section 341, and then added to the order taker's voice signal containing the original sound, causing the talk back sound to be delayed at the order taker head speaker 321. This means that the sound signal segments contained in the base station signal corresponding to the talk back sound arrive at the order taker head speaker 321 later than the sound signal segments contained in the base station signal corresponding to the original sound by a time period elapsed for the processing performed by the signal processing section 341 as shown in FIG. 6. In FIG. 6, the sound signal segments corresponding to the talk back sound is delayed by more than 20 milliseconds.

The sound signal segments corresponding to the talk back sound arrives at the order taker head speaker 321 later than the sound signal segments corresponding to the original sound by more than 10 milliseconds; the order taker head speaker 321 of the order taker headset 320 audibly outputs the talk back sound later than the original sound by more than 10 milliseconds, the order taker wearing the order taker headset 320 listening to the talk back sound delayed by more than 10 milliseconds may mishear the talk back sound for reverberations, thereby making it difficult for the order taker to accurately take the order. This leads to the fact that the time period required for the processing performed by the signal processing section of the base station in the conventional drive through system 300 has been limited to not more than 10 milliseconds. The present invention contemplates resolution of such problems.

### SUMMARY OF THE INVENTION

It is therefore an object of the present invention to provide a base station, which does not limit the time period required for the processing performed by the signal processing section of the base station, but can prevent the talk back sound from being delayed and misheard for reverberations, thereby making it easy for an order taker to accurately take the order.

It is another object of the present invention to provide a drive through system comprising a base station, which does not limit the time period required for the processing performed by the signal processing section of the base station, but can prevent the talk back sound from being delayed and misheard for reverberations, thereby making it easy for an order taker to accurately take the order.

It is a further object of the present invention to provide a base station method, which does not limit the time period required for the processing performed by the signal processing section of the base station, but can prevent the talk back sound from being delayed and misheard for reverberations, thereby making it easy for an order taker to accurately take the order.

It is a still further object of the present invention to provide a drive through method, which does not limit the time period required for the processing performed by the signal processing section of the base station, but can prevent the talk back sound from being delayed and misheard for reverberations, thereby making it easy for an order taker to accurately take the order.

In accordance with a first aspect of the present invention, there is provided a drive through system comprising: a far-end station for collecting a far-end voice; a near-end station for audibly outputting the far-end voice, and collecting near-end sounds around the near-end station including the far-end voice thus audibly outputted; a base station for processing a near-end sound signal indicative of the near-end sounds collected by the near-end station, and adding a far-end voice signal indicative of the far-end voice collected by the far-end station to the near-end sound signal thus processed to ensure that a reverberation free processed sound including a near-end sounds containing the far-end voice is generated.

The aforesaid far-end station may include a far-end voice inputting section for collecting a far-end voice, and converting the far-end voice thus collected into a far-end voice signal, the base station comprises a base receiving section for receiving the far-end voice signal converted by the far-end voice inputting section of the far-end station, the near-end station includes a far-end voice outputting section for converting the far-end voice signal received by the base receiving section into the far-end voice, and audibly outputting the far-end voice; the near-end station further includes a near-end sound inputting section for collecting near-end sounds around the near-end station including the far-end voice thus audibly outputted, and converting the near-end sounds thus collected into a near-end sound signal including a sound signal segments corresponding to the far-end voice.

The aforesaid base station further may comprise a signal processing section for generating a reverberation-free processed sound signal on the basis of the near-end sound signal converted by the near-end sound inputting section and the far-end voice signal received by the base receiving section, The signal processing section may include: a storing portion for storing the far-end voice signal received by the base receiving section; and an input signal processing portion for processing the near-end sound signal including a sound signal segments corresponding to the far-end voice converted by the near-end sound inputting section of the near-end station to generate a processed near-end sound signal including a processed sound signal segments corresponding to the far-end voice, and adding the far-end voice signal stored by the storing portion to the processed near-end sound signal to generate the reverberation-free processed sound signal in which the processed sound signal segments corresponding to the far-end voice and the sound signal segments corresponding to the far-end voice are substantially matched, a base transmitting section for transmitting the reverberation-free processed sound signal generated by the input signal processing portion, the far-end station further includes a near-end sound outputting section for converting the reverberation-free processed sound signal transmitted by the base transmitting section of the base station into a reverberation-free processed sound to be audibly outputted therethrough.

The aforesaid drive through system may further comprise: a communications station including: a communications station receiving section for receiving the reverberation-free processed sound signal transmitted by the base transmitting section of the base station; and a communications station transmitting section for transmitting the far-end voice signal converted by the far-end voice inputting section, in which the near-end sound outputting section is operative to input the reverberation-free processed sound signal received by the communications station receiving section of the communications station to be converted to a reverberation-free processed sound and audibly outputted therethrough, and the base receiving section of the base station is operative to receive the far-end voice signal transmitted by the communications station transmitting section of the communications station.

In accordance with a second aspect of the present invention, there is provided a base station comprising: a base receiving section for receiving a far-end voice signal converted from a far-end voice; a signal processing section for generating a reverberation-free processed sound signal, the signal processing section including: a storing portion for storing the far-end voice signal received by the base receiving section; and an input signal processing portion for processing a near-end sound signal including a sound signal segments corresponding to the far-end voice to generate a processed near-end sound signal including a processed sound signal segments corresponding to the far-end voice, and adding the far-end voice signal stored by the storing portion to the processed near-end sound signal to generate the reverberation-free processed sound signal in which the processed sound signal segments corresponding to the far-end voice and the sound signal segments corresponding to the far-end voice are substantially matched, and a base transmitting section for transmitting the reverberation-free processed sound signal generated by the input signal processing portion.

In accordance with a third aspect of the present invention, there is provided a drive through method comprising the steps of: a preparing step of preparing: a far-end station for collecting a far-end voice; a near-end station for audibly outputting the far-end voice, and collecting near-end sounds around the near-end station including the far-end voice thus audibly outputted; a base station for processing a near-end sound signal indicative of the near-end sounds collected by the near-end station, and adding a far-end voice signal indicative of the far-end voice collected by the far-end station to the near-end sound signal thus processed to ensure that a reverberation free processed sound including a near-end sounds containing the far-end voice is generated, whereby the far-end station includes a far-end voice inputting section for collecting a far-end voice, and converting the far-end voice thus collected into a far-end voice signal, the base station comprises a base receiving section for receiving the far-end voice signal converted by the far-end voice inputting section of the far-end station, the near-end station includes a far-end voice outputting section for converting the far-end voice signal received by the base receiving section into the far-end voice, and audibly outputting the far-end voice; the near-end station further includes a near-end sound inputting section for collecting near-end sounds around the near-end station including the far-end voice thus audibly outputted, and converting the near-end sounds thus collected into a near-end sound signal including a sound signal segments corresponding to the far-end voice; the base station further comprises: a signal processing section for generating a reverberation-free processed sound signal on the basis of the near-end sound signal converted by the near-end sound inputting section and the far-end voice signal received by the base receiving section, the signal processing section includes: a storing portion for storing the far-end voice signal received by the base receiving section; and an input signal processing portion for processing the near-end sound signal including a sound signal segments corresponding to the far-end voice converted by the near-end sound inputting section of the near-end station to generate a processed near-end sound signal including a processed sound signal segments corresponding to the far-end voice, and adding the far-end voice signal stored by the storing portion to the processed near-end sound signal to generate the reverberation-free processed sound signal in which the processed sound signal segments corresponding to the far-end voice and the sound signal segments corresponding to the far-end voice are substantially matched, and a base transmitting section for transmitting the reverberation-free processed sound signal generated by the input signal processing portion, the far-end station further includes a near-end sound outputting section for converting the reverberation-free processed sound signal transmitted by the base transmitting section of the base station into a reverberation-free processed sound to be audibly outputted therethrough, a near-end sound outputting step of having the near-end sound outputting section of the far-end station convert the reverberation-free processed sound signal transmitted by the base transmitting section of the base station into a reverberation-free processed sound to be audibly outputted therethrough.

In accordance with a fourth aspect of the present invention, there is provided a base station method comprising the steps of: a preparing step of preparing: a base receiving section for receiving a far-end voice signal converted from a far-end voice; a signal processing section for generating a reverberation-free processed sound signal, the signal processing section including: a storing portion for storing the far-end voice signal received by the base receiving section; and an input signal processing portion for processing a near-end sound signal including a sound signal segments corresponding to the far-end voice to generate a processed near-end sound signal including a processed sound signal segments corresponding to the far-end voice, and adding the far-end voice signal stored by the storing portion to the processed near-end sound signal to generate the reverberation-free processed sound signal in which the processed sound signal segments corresponding to the far-end voice and the sound signal segments corresponding to the far-end voice are substantially matched, and a base transmitting section for transmitting the reverberation-free processed sound signal generated by the input signal processing portion, base transmitting step of having the base transmitting section transmit the reverberation-free processed sound signal generated by the input signal processing portion.

### BRIEF DESCRIPTION OF THE DRAWINGS

The present invention and many of the advantages thereof will be better understood from the following detailed description when considered in connection with the accompanying drawings, wherein:

FIG. 1 is a schematic block diagram explaining a preferred embodiment of the drive through system according to the present invention;

FIG. 2 is a block diagram of a menu board, an order taker headset, an order taker station, and a base station collectively forming the drive through system shown in FIG. 1;

FIG. 3 is a graph showing a result of the signal processing performed in the drive through system shown in FIG. 2;

FIG. 4 is a schematic block diagram explaining a conventional drive through system;

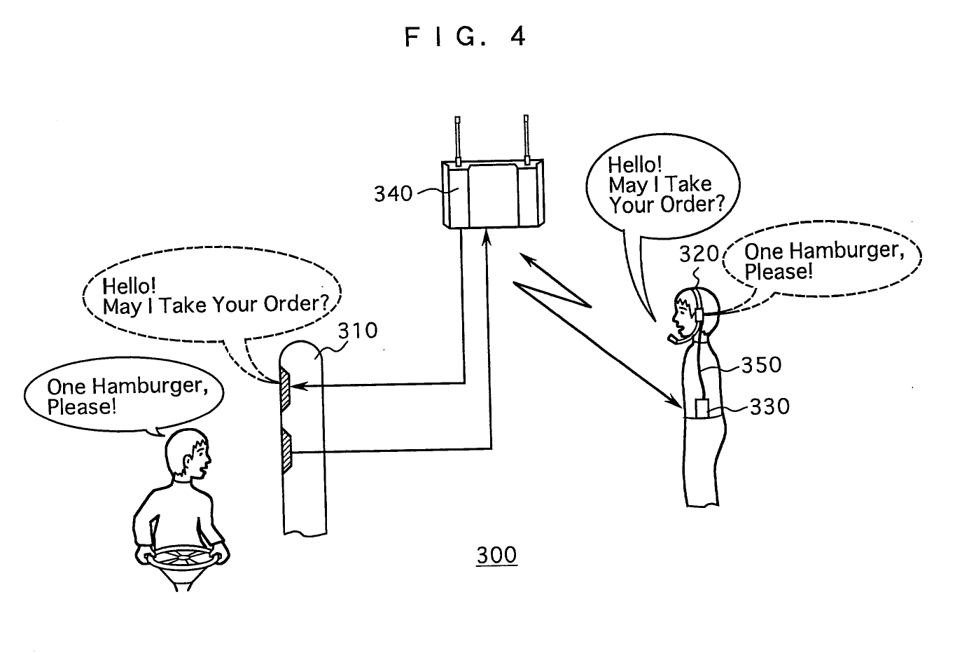

FIG. 5 is block diagram of a menu board, an order taker headset, an order taker station, and a base station collectively forming the conventional drive through system shown in FIG. 1; and

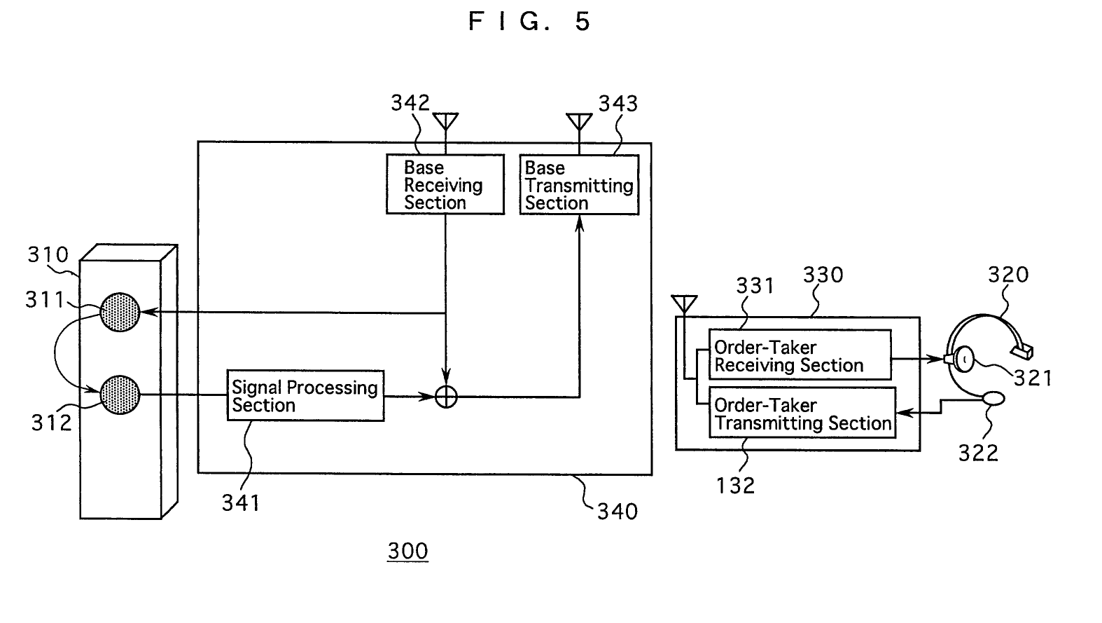

FIG. 6 is a graph showing a result of the signal processing performed in the conventional drive through system shown in FIG. 4.

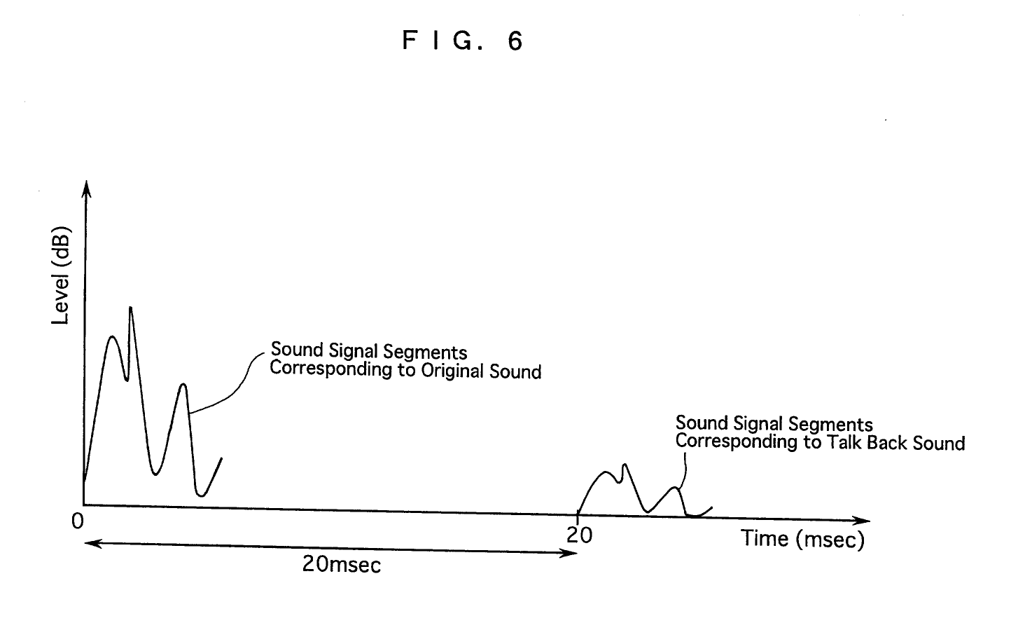

### DESCRIPTION OF THE PREFERRED EMBODIMENTS

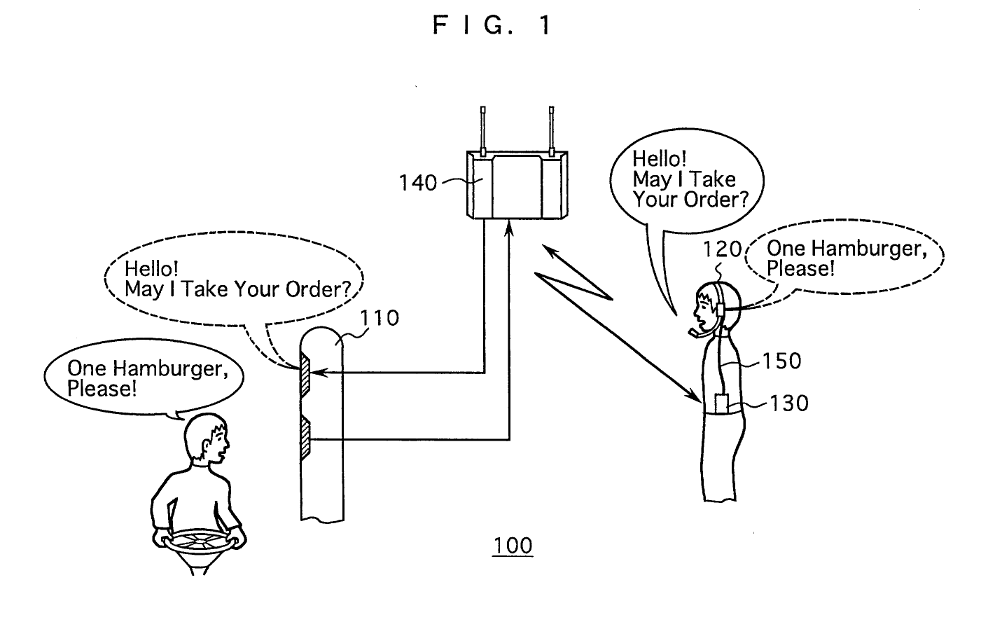

The preferred embodiment of the drive through system 100 according to the present invention will be described hereinafter with reference to the drawings shown in FIGS. 1 to 3. Throughout the following detailed description, similar reference characters refer to similar elements in all figures of the drawings.

Referring now to FIG. 1 of the drawings, there is shown a preferred embodiment of the drive through system 100 comprising a base station 140 according to the present invention.

The drive through system 100 is shown in FIG. 1 as comprising: a menu board 110, an order taker headset 120, an order taker station 130, and a base station 140. The order taker headset 320 is worn on the head of an order taker. The term “order taker” herein used is intended to mean a clerk taking an order in the shop from the customer, for example, driving a car, outside the shop. The order taker station 330 is carried by the order taker.

The order taker headset 120 is designed to collect a sound around the order taker headset 120. The order taker may speak up, for example, “Hello! May I take your order?” The sound collected by the order taker headset 120 will be hereinlater simply referred to as “an order taker voice”. The menu board 110 is designed to audibly output the order taker voice, and collect sounds around the menu board 110 including the order taker voice thus audibly outputted. The menu board 110 is placed outside of a shop and into which a customer driving a car, outside the shop, may speak up an order, for example, “One hamburger, please!” The sounds collected by the menu board 110 will be hereinlater simply referred to as “menu board sounds”. The base station 140 is designed to process a menu board sound signal indicative of the menu board sounds collected by the menu board 110, and to add an order taker voice signal indicative of the order taker voice collected by the order taker headset 120 to the menu board sound signal thus processed to ensure that a reverberation free processed sound including a menu board sounds containing the order taker voice is generated. The order taker headset 120 is connected with the order taker station 130 through a cable 150. The menu board 110 constitutes the near-end station according to the present invention, the order taker headset 120 constitutes the far-end station according to the present invention, and the order taker station 130 constitutes the communications station according to the present invention.

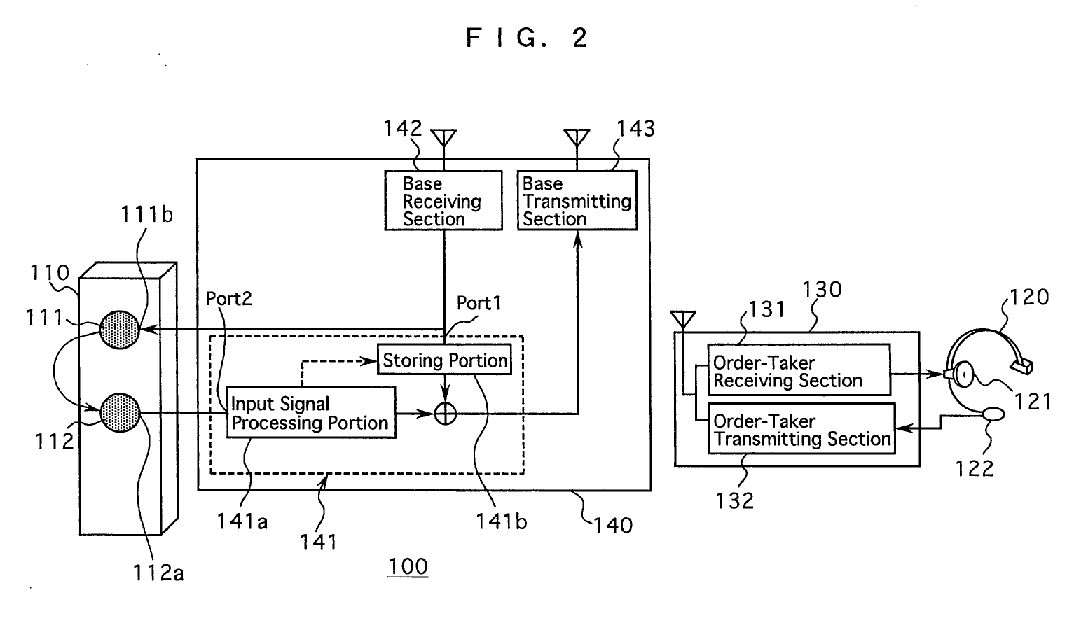

The drive through system according to the present invention will be described in detail with reference to the drawings shown in FIG. 2.

The order taker headset 120 includes an order taker head microphone 122. The order taker head microphone 122 is designed to collect a sound around the order taker head microphone 122. The order taker may speak up into the order taker head microphone 122, for example, “Hello! May I take your order?” The order taker head microphone 122 is operative to collect a sound around the order taker head microphone 122, hereinlater simply referred to as “an order taker voice”, and convert the order taker voice thus collected into an order taker voice signal.

The base station 140 comprises a base receiving section 142. The base receiving section 142 is designed to receive the order taker voice signal converted by the order taker head microphone 122 of the order taker headset 120.

The menu board speaker 111 includes a menu board speaker 111. The menu board speaker 111 has a terminal 111b having the order taker voice signal received by the base receiving section 142 inputted therethrough. The menu board speaker 111 is designed to convert the order taker voice signal into the order taker voice, and audibly output the order taker voice, for example, “Hello! May I take your order?” The menu board 110 further includes a menu board microphone 112. The menu board microphone 112 is designed to collect sounds around the menu board 110. A customer speaks up an order, for example, “One hamburger, please” around the menu board in response to the order taker voice audibly outputted by the menu board speaker 111. The menu board microphone 112 is operative to collect the order spoken up by the customer.

The order taker voice audibly outputted by the menu board speaker 111 is reflected from objects surrounding the menu board 110 such as, for example, cars. This means that the sounds including the order taker voice thus audibly outputted by the menu board speaker 111 and reflected from objects surrounding the menu board 110 are collected by the menu board microphone 112 in addition to the order spoken up by the customer. The sounds collected by the menu board microphone 112 will be hereinlater simply referred to as “menu board sounds”. The menu board microphone 112 is designed to convert the menu board sounds thus collected into a menu board sound signal including a sound signal segments corresponding to the order taker voice, for example, “Hello! May I take your order?” The order taker voice outputted by the menu board speaker 111 will be referred to as “original sound”. The order taker voice collected by the menu board microphone will be referred to as “talk back sound”. The menu board microphone 112 has a terminal 112a having the menu board sound signal outputted therethrough.

The base station 140 further comprises a signal processing section 141. The signal processing section 141 is designed to generate a reverberation-free processed sound signal, which will be described later, on the basis of the menu board sound signal converted by the menu board microphone 112 and the order taker voice signal received by the base receiving section 142.

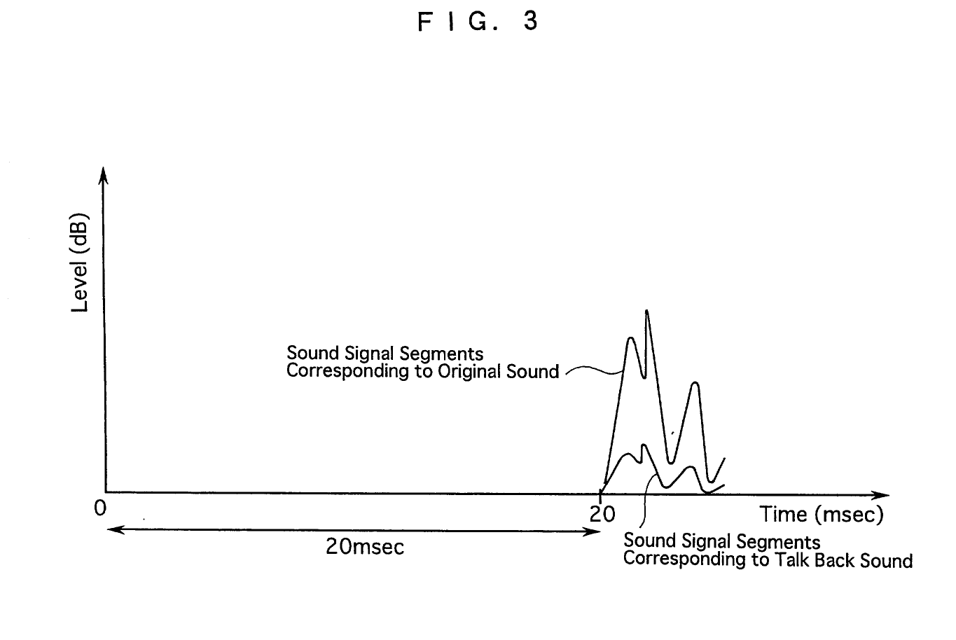

The signal processing section 141 includes an input signal processing portion 141a and a storing portion 141b. The storing portion 141b is designed to store the order taker voice signal received by the base receiving section 142. The storing portion 141b has a port 1 having the order taker voice signal inputted therethrough. The input signal processing portion 141a has a port 2 having the menu board sound signal inputted therethrough. The input signal processing portion 141a is designed to process the menu board sound signal including a sound signal segments corresponding to the order taker voice converted by the menu board microphone 112 of the menu board 110 to generate a processed menu board sound signal including a processed sound signal segments corresponding to the order taker voice. The input signal processing portion 141a may process the menu board sound signal so as to reduce noise components contained in the menu board sound signal by way of, for example but not limited to, Digital Noise Reduction (DNR), Digital Filter (FIR Filter), or Howling Suppressor, or any combination thereof. The input signal processing portion 141a is designed to add the order taker voice signal stored by the storing portion 141b to the processed menu board sound signal. The input signal processing portion 141a, in which the order taker voice signal stored by the storing portion 141b is added to the processed menu board sound signal, can generate a reverberation-free processed sound signal, in which the processed sound signal segments corresponding to the order taker voice, i.e., talk back sound, and the sound signal segments corresponding to the order taker voice, i.e., original sound, are substantially matched as shown in FIG. 3 regardless of the time period elapsed for the processing performed by the input signal processing portion 141a. Preferably, the input signal processing portion 141a may add the order taker voice signal stored by the storing portion 141b to the processed menu board sound signal in a manner that the head of the order taker voice signal is synchronized with the head of the processed menu board sound signal.

The base station 140 further includes a base transmitting section 143. The base transmitting section 143 is designed to transmit the reverberation-free processed sound signal generated by the signal processing section 141.

The order taker headset 120 further includes an order taker head speaker 121. The order taker head speaker is designed to convert the reverberation-free processed sound signal transmitted by the base transmitting section 143 of the base station 140 into a reverberation-free processed sound to be audibly outputted therethrough.

The drive through system 100 further comprises an order taker station 130. The order taker station 130 includes an order taker receiving section 131 and an order taker transmitting section 132. The order taker receiving section 131 is designed to receive the reverberation-free processed sound signal transmitted by the base transmitting section 143 of the base station 140. The order taker transmitting section 132 is designed to transmit the order taker voice signal converted by the order taker head microphone 122. The order taker head speaker 121 is operative to input the reverberation-free processed sound signal received by the order taker receiving section 131 of the order taker station 130 to be converted to a reverberation-free processed sound and audibly outputted therethrough. The base receiving section 142 of the base station 140 is operative to receive the order taker voice signal transmitted by the order taker transmitting section 132 of the order taker station 130.

The operation of the drive through system 100 will be described hereinlater.

In the order taker headset 120, the order taker head microphone 122 is operated to collect a sound around the order taker head microphone 122. The order taker may speak up into the order taker head microphone 122, for example, “Hello! May I take your order?” The order taker head microphone 122 is operative to collect a sound around the order taker head microphone 122, i.e., “an order taker voice”, and convert the order taker voice thus collected into an order taker voice signal.

In the base station 140, the base receiving section 142 is operated to receive the order taker voice signal converted by the order taker head microphone 122 of the order taker headset 120.

In the menu board speaker 111, the menu board speaker 111 is operated to input the order taker voice signal received by the base receiving section 142 and convert the order taker voice signal into the order taker voice, and audibly output the order taker voice, for example, “Hello! May I take your order?” In the menu board 110, the menu board microphone 112 is operated to collect sounds around the menu board 110. A customer speaks up an order, for example, “One hamburger, please” around the menu board in response to the order taker voice audibly outputted by the menu board speaker 111. The menu board microphone 112 is operative to collect the order spoken up by the customer. More specifically, the menu board microphone 112 is operative to collect the sound including the order taker voice audibly outputted by the menu board speaker 111, and reflected from objects surrounding the menu board 110 in addition to the order spoken up by the customer. The menu board microphone 112 is operated to convert the menu board sounds thus collected into a menu board sound signal including a sound signal segments corresponding to the order taker voice, for example, “Hello! May I take your order?”

In the base station 140, the storing portion 141b is operated to store the order taker voice signal received by the base receiving section 142. The input signal processing portion 141a is operated to process the menu board sound signal including a sound signal segments corresponding to the order taker voice converted by the menu board microphone 112 of the menu board 110 to generate a processed menu board sound signal including a processed sound signal segments corresponding to the order taker voice. The input signal processing portion 141a is operated to add the order taker voice signal stored by the storing portion 141b to the processed menu board sound signal to generate a reverberation-free processed sound signal, in which the processed sound signal segments corresponding to the order taker voice, i.e., talk back sound, and the sound signal segments corresponding to the order taker voice, i.e., original sound, are substantially matched as shown in FIG. 3 regardless of the time period elapsed for the processing performed by the input signal processing portion 141a. Preferably, the input signal processing portion 141a is operative to add the order taker voice signal stored by the storing portion 141b to the processed menu board sound signal in a manner that the head of the order taker voice signal is synchronized with the head of the processed menu board sound signal.

The base transmitting section 143 is operated to transmit the reverberation-free processed sound signal generated by the signal processing section 141.

The base station 140 according to the present invention, in which the input signal processing portion 141a adds the order taker voice signal stored by the storing portion 141b to the processed menu board sound signal, does not need to limit the time period required for the processing performed by the signal processing section 141 of the base station, but can prevent the talk back sound from being delayed and misheard for reverberations, thereby making it easy for an order taker to accurately take the order.

In the order taker headset 120, the order taker head speaker 121 is operated to convert the reverberation-free processed sound signal transmitted by the base transmitting section 143 of the base station 140 into a reverberation-free processed sound to be audibly outputted therethrough.

The drive through system 100 further comprises an order taker station 130. The order taker station 130 includes an order taker receiving section 131 and an order taker transmitting section 132. The order taker receiving section 131 is operated to receive the reverberation-free processed sound signal transmitted by the base transmitting section 143 of the base station 140. The order taker transmitting section 132 is operated to transmit the order taker voice signal converted by the order taker head microphone 122. The order taker head speaker 121 is operative to input the reverberation-free processed sound signal received by the order taker receiving section 131 of the order taker station 130 to be converted to a reverberation-free processed sound and audibly outputted therethrough. The base receiving section 142 of the base station 140 is operative to receive the order taker voice signal transmitted by the order taker transmitting section 132 of the order taker station 130.

The drive through system comprising the base station 140 according to the present invention, in which the input signal processing portion 141a adds the order taker voice signal stored by the storing portion 141b to the processed menu board sound signal, does not need to limit the time period required for the processing performed by the signal processing section 141 of the base station, but can prevent the talk back sound from being delayed and misheard for reverberations, thereby making it easy for an order taker to accurately take the order.

Those skilled in the art having the benefit of the teachings of the present invention as hereinabove set forth, can effect numerous modifications thereto. These modifications are to be construed as being encompassed within the scope of the present invention as set forth in the appended claims.

What is claimed is:

1. A drive through system comprising: a far-end station for collecting a far-end voice; a near-end station for audibly outputting said far-end voice, and collecting near-end sounds around said near-end station including said far-end voice thus audibly outputted; a base station for processing a near-end sound signal indicative of said near-end sounds collected by said near-end station, and adding a far-end voice signal indicative of said far-end voice collected by said far-end station to said near-end sound signal thus processed to ensure that a reverberation free processed sound including a near-end sounds containing said far-end voice is generated, whereby
said far-end station includes a far-end voice inputting section for collecting a far-end voice, and converting said far-end voice thus collected into a far-end voice signal,
said base station comprises a base receiving section for receiving said far-end voice signal converted by said far-end voice inputting section of said far-end station,
said near-end station includes a far-end voice outputting section for converting said far-end voice signal received by said base receiving section into said far-end voice, and audibly outputting said far-end voice;
said near-end station further includes a near-end sound inputting section for collecting near-end sounds around said near-end station including said far-end voice thus audibly outputted, and converting said near-end sounds thus collected into a near-end sound signal including a sound signal segments corresponding to said far-end voice;
said base station further comprises:
a signal processing section for generating a reverberation-free processed sound signal on the basis of said near-end sound signal converted by said near-end sound inputting section and said far-end voice signal received by said base receiving section,
said signal processing section includes:
a storing portion for storing said far-end voice signal received by said base receiving section; and
an input signal processing portion for processing said near-end sound signal including a sound signal segments corresponding to said far-end voice converted by said near-end sound inputting section of said near-end station to generate a processed near-end sound signal including a processed sound signal segments corresponding to said far-end voice, and adding said far-end voice signal stored by said storing portion to said processed near-end sound signal to generate said reverberation-free processed sound signal in which said processed sound signal segments corresponding to said far-end voice and said sound signal segments corresponding to said far-end voice are substantially matched; and
a base transmitting section for transmitting said reverberation-free processed sound signal generated by said input signal processing portion,
said far-end station further includes a near-end sound outputting section for converting said reverberation-free processed sound signal transmitted by said base transmitting section of said base station into a reverberation-free processed sound to be audibly outputted therethrough.

2. A drive through system as set forth in claim 1, in which
said input signal processing portion is operative to process said near-end sound signal including a sound signal segments corresponding to said far-end voice converted by said near-end sound inputting section of said near-end station to generate a processed near-end sound signal including a processed sound signal segments corresponding to said far-end voice, and to add said far-end voice signal stored by said storing portion to said processed near-end sound signal in a manner that the head of said far-end voice signal is synchronized with the head of said processed near-end sound signal to generate said reverberation-free processed sound signal which said processed sound signal segments corresponding to said far-end voice and said sound signal segments corresponding to said far-end voice are substantially matched,

3. A drive through system as set forth in claim 1, in which said input signal processing portion is operative to process said near-end sound signal so as to reduce noise components contained in said near-end sound signal.

4. A drive through system as set forth in claim 1, in which
an order taker speaks up into said far-end voice inputting section, said far-end voice inputting section is operative to collect said order taker's voice, and
a customer speaks up an order around said near-end station, said near-end sound inputting section is operative to collect said order spoken up by the customer.

5. A drive through system as set forth in claim 1, further comprising:
a communications station including:
a communications station receiving section for receiving said reverberation-free processed sound signal transmitted by said base transmitting section of said base station; and
a communications station transmitting section for transmitting said far-end voice signal converted by said far-end voice inputting section, in which
said near-end sound outputting section is operative to input said reverberation-free processed sound signal received by said communications station receiving section of said communications station to be converted to a reverberation-free processed sound and audibly outputted therethrough, and
said base receiving section of said base station is operative to receive said far-end voice signal transmitted by said communications station transmitting section of said communications station.

6. A base station comprising:
a base receiving section for receiving a far-end voice signal converted from a far-end voice;
a signal processing section for generating a reverberation-free processed sound signal, said signal processing section including:
a storing portion for storing said far-end voice signal received by said base receiving section; and
an input signal processing portion for processing a near-end sound signal including a sound signal segments corresponding to said far-end voice to generate a processed near-end sound signal including a processed sound signal segments corresponding to said far-end voice, and adding said far-end voice signal stored by said storing portion to said processed near-end sound signal to generate said reverberation-free processed sound signal in which said processed sound signal segments corresponding to said far-end voice and said sound signal segments corresponding to said far-end voice are substantially matched, and
a base transmitting section for transmitting said reverberation-free processed sound signal generated by said input signal processing portion.

7. A base station as set forth in claim 6, in which
said input signal processing portion is operative to process a near-end sound signal including a sound signal segments corresponding to said far-end voice to generate a processed near-end sound signal including a processed sound signal segments corresponding to said far-end voice, and to add said far-end voice signal stored by said storing portion to said processed near-end sound signal in a manner that the head of said far-end voice signal is synchronized with the head of said processed near-end sound signal to generate said reverberation-free processed sound signal in which said processed sound signal segments corresponding to said far-end voice and said sound signal segments corresponding to said far-end voice are substantially matched, and

8. A base station as set forth in claim 6, in which said input signal processing portion is operative to process said near-end sound signal so as to reduce noise components contained in said near-end sound signal.

9. An drive through method comprising the steps of:
a preparing step of preparing:
a far-end station for collecting a far-end voice; a near-end station for audibly outputting said far-end voice, and collecting near-end sounds around said near-end station including said far-end voice thus audibly outputted; a base station for processing a near-end sound signal indicative of said near-end sounds collected by said near-end station, and adding a far-end voice signal indicative of said far-end voice collected by said far-end station to said near-end sound signal thus processed to ensure that a reverberation free processed sound including a near-end sounds containing said far-end voice is generated, whereby
said far-end station includes a far-end voice inputting section for collecting a far-end voice, and converting said far-end voice thus collected into a far-end voice signal,
said base station comprises a base receiving section for receiving said far-end voice signal converted by said far-end voice inputting section of said far-end station,
said near-end station includes a far-end voice outputting section for converting said far-end voice signal received by said base receiving section into said far-end voice, and audibly outputting said far-end voice;
said near-end station further includes a near-end sound inputting section for collecting near-end sounds around said near-end station including said far-end voice thus audibly outputted, and converting said near-end sounds thus collected into a near-end sound signal including a sound signal segments corresponding to said far-end voice;
said base station further comprises:
a signal processing section for generating a reverberation-free processed sound signal on the basis of said near-end sound signal converted by said near-end sound inputting section and said far-end voice signal received by said base receiving section,
said signal processing section includes:
a storing portion for storing said far-end voice signal received by said base receiving section; and
an input signal processing portion for processing said near-end sound signal including a sound signal segments corresponding to said far-end voice converted by said near-end sound inputting section of said near-end station to generate a processed near-end sound signal including a processed sound signal segments corresponding to said far-end voice, and adding said far-end voice signal stored by said storing portion to said processed near-end sound signal to generate said reverberation-free processed sound signal in which said processed sound signal segments corresponding to said far-end voice and said sound signal segments corresponding to said far-end voice are substantially matched, and
a base transmitting section for transmitting said reverberation-free processed sound signal generated by said input signal processing portion,
said far-end station further includes a near-end sound outputting section for converting said reverberation-free processed sound signal transmitted by said base transmitting section of said base station into a reverberation-free processed sound to be audibly outputted therethrough,
a near-end sound outputting step of having said near-end sound outputting section of said far-end station convert said reverberation-free processed sound signal transmitted by said base transmitting section of said base station into a reverberation-free processed sound to be audibly outputted therethrough.

10. A base station method comprising the steps of:
a preparing step of preparing:
a base receiving section for receiving a far-end voice signal converted from a far-end voice;
a signal processing section for generating a reverberation-free processed sound signal, said signal processing section including:
a storing portion for storing said far-end voice signal received by said base receiving section; and
an input signal processing portion for processing a near-end sound signal including a sound signal segments corresponding to said far-end voice to generate a processed near-end sound signal including a processed sound signal segments corresponding to said far-end voice, and adding said far-end voice signal stored by said storing portion to said processed near-end sound signal to generate said reverberation-free processed sound signal in which said processed sound signal segments corresponding to said far-end voice and said sound signal segments corresponding to said far-end voice are substantially matched, and
a base transmitting section for transmitting said reverberation-free processed sound signal generated by said input signal processing portion,
a base transmitting step of having said base transmitting section transmit said reverberation-free processed sound signal generated by said input signal processing portion.
